(19) United States
(12) Patent Application Publication
(10) Pub. No.: US 2017/0296910 A1
(43) Pub. Date: Oct. 19, 2017

(54) TABLE TOP GAME BOARD SYSTEM AND COOPERATING COMPONENTS

(71) Applicants: Hermon Alan Boyd, Red Oak, TX (US); Geoffrey Alan Boyd, Berlin (DE)

(72) Inventors: Hermon Alan Boyd, Red Oak, TX (US); Geoffrey Alan Boyd, Berlin (DE)

(21) Appl. No.: 15/488,448

(22) Filed: Apr. 15, 2017

Related U.S. Application Data
(60) Provisional application No. 62/323,658, filed on Apr. 16, 2016.

(51) Int. Cl. A63F 3/00; A63F 13/822; A63F 13/335

(52) U.S. Cl. CPC A63F 3/00097; A63F 3/00574; A63F 13/822; A63F 3/00082; A63F 3/00176; A63F 13/335; A63F 2003/00182; A63F 2003/00195; A63F 2003/00583; A63F 2003/00996

(57) ABSTRACT

The present invention comprises a chance and strategy game system wherein pawns race to home through a continuously changing maze. The movement of the maze barrier members and the pawns, which occurs with each player's turn, has the surprising benefit of continually rebalancing the likelihood of winning. Because of this characteristic, the game works well for a mixture all ages and experience levels. It is a very family friendly game since all players experience many little wins throughout the game. The game works for 2 or more players as individuals or as teams. In addition, it is one of the few board games that can end in a tie.

### CROSS-REFERENCE TO RELATED APPLICATIONS

The present application claims the benefit of U.S. provisional patent application Ser. No. 62/323,658, Titled: Table Top Game Apparatus With Movable Pieces, Filed: Apr. 16, 2016, by the present inventors, Hermon Alan Boyd and Geoffrey Alan Boyd which is incorporated by reference in its entirety.

### TECHNICAL FIELD

The present invention relates to board games, and more particularly to race-to-home board games incorporating both chance and strategy.

### BACKGROUND—PRIOR ART

The following is a tabulation of some prior art that presently appears relevant.

### U.S. PATENTS

| Patent Number | Kind Code | Issue Date | Patentee |
|---|---|---|---|
| 3,155,391 | A | 1964 Nov. 3 | Chittenden |
| 5,108,109 | A | 1991 May 28 | Leban |
| 5,018,743 | A | 1992 Apr. 28 | Maier and Maier |
| 3,820,791 | A | 1974 Jun. 28 | Powers |
| 2,585,268 | A | 1952 Feb. 12 | Olsen |
| 3,731,934 | A | 1973 May 8 | Shoptaugh |

### NONPATENT REFERENCE

The popular game “Quoridor” provides a maze based race to finish game.

I have noticed that, for many board games where both strategy and chance are elements, early good luck strongly bias the outcome. The ultimate winner of such board games is often determined early in the game and later strategy by other player or players is ineffective in changing the outcome. The game can become uninteresting as it provides fewer and fewer optimistic mid-game experiences to the eventual losers. In addition, the dynamics of almost all strategy and chance games lack the element of shifting the balance of opportunity to the more disadvantaged as the game nears completion. In some games, when pieces are captured and removed from play, the advantage difference is heightened as the game goes on.

I have noticed, also, many games lack the versatility to be played either as partners or as individuals. Some games work well only w/ several simultaneous players and lack interest as a two player game. Or, a game is only useful as a two player game.

Generally, board games cannot end in a tie.

Board games that have upgrades, generally, simply add more of the same. For example: the size of the board may be increased and additional tokens may be provided. These changes do not provide new options in play strategy or change the player's experience.

I have also noticed that colors chosen for game boards do not always work well for colorblind players. This has become more of a problem as indoor lighting changes from incandescent to alternatives with shifted or narrow wave-length spectrums. The net result is that colorblind players find it difficult to differentiate like shaped tokens based on color alone.

Games have many interacting components that have meaning based on their placement on the board. However, there is often no robust means for keeping the pieces in place in the event of light jostling which can easily occur in animated game play.

Each of the games in the referenced prior art has a method for modifying the playing board. Generally, the method includes either variations on playing board tile placement, or sliding elements, or both.

Playing board modification by tile placement is used in U.S. Pat. No. 3,820,791 by Powers, U.S. Pat. No. 2,585,268 by Olsen, and U.S. Pat. No. 3,155,391 by Chittenden. However for all of these patents, once placed the tiles cannot be changed during a game and there is no element of chance. The game then becomes a tactical game where the more skilled player is highly likely to win. In addition, in the patent by Olsen, opponent's tokens can be removed during game play, thereby further unbalancing the opportunity to win by an unskilled player. In U.S. Pat. No. 5,108,109 by Lebon, the tile layout completely defines the playing board and continuously changes as the game progresses. However, there is no element of chance and the most experienced or skilled player is likely to win.

Another way to make a changing game board is with sliding elements. U.S. Pat. No. 5,018,743 by Maier and Maier is an example of a game board with tiles such that, when a tile is inserted into an edge of the game board, the layout of one portion of the game board shifts. Again this game does not incorporate chance so as to enhance the opportunity for the less skilled player to win. U.S. Pat. No. 3,731,934 by Shoptaugh incorporates sliding members with built in barrier members. Again, there is no element of chance. Also, the barrier members remain unchangeable on the sliding members.

The popular game “Quoridor” is a tactical game played with a single pawn for each player and with maze walls that are only one size. Also the maze wall remains unmovable after being placed, for the duration of the game. It cannot end in a tie. It does not combine chance and strategy. Also, there is no team play.

All strategy and chance board games of which I am aware suffer from one or more of the following disadvantages:

(a) Previous experience or tactical skills strongly bias the outcome of the game.

(b) Early luck strongly biases the outcome of the game.

(c) When game pieces are removed from the board, the imbalance of advantage becomes more biased.

(d) Games do not have a balancing mechanism such that game strategy for winning the game typically shifts from starting and gives opportunity for opponents to catch-up.

(e) The game cannot end in a tie.

(f) Typically, a particular game does not work equally well for playing as teams and for playing as individuals.

(g) Game upgrades are simply add-ons that make the game bigger without adding game variations.

(h) Pawns or tokens are often all shaped similarly and differentiated only by color which sometimes handicaps colorblind players.

(i) Interacting game board pieces ae generally not robustly held in place on the playing surface.

### SUMMARY

In accordance with one embodiment a game board system comprises several cooperating components, including: a substantially flat equal-sided polygonal playing surface, a plurality of maze barrier members, a plurality of pawns, a numbered die, and a special die. The polygonal playing surface is divided into pads which are separated by a channel between adjacent pad edges. The fewest number of channels required to be crossed when moving a pawn from one side to the opposite side of the playing surface is equal to the highest number on the numbered die. The pads that circumvent the playing surface are identified by color such that each side of the polygonal playing surface is associated with a different color. Pads on a corner of the playing surface, at the intersection of two sides, have the colors of both sides. A row of pads along one side having the same color is designated as HOME. The plurality of pawns is divided into sets of equal number. The number of sets equals the number of sides of the playing surface. Each set is identified by one of the colors used to identify HOME.

These cooperating game board components combined with simple rules of play provide a game wherein every player's optimal strategy shifts from beginning to end and what is advantageous to the apparent winning player near the end also enhances the rate of catch up for an opponent. In addition, all pawns remain in play for the whole game. The game board paths shift with almost every player's turn. The game can be played either as individuals or as teams. It can also end in a tie. In addition, each pawn is identified by two shape characteristics in addition to color. These multi-level pawn identifier characteristics provide for better identification of pieces for colorblind individuals in both individual play and in team play.

### Advantages

Accordingly several advantages for one or more aspects are as follows: to use simple rules for a game system, to create a strategic urging for a shift of a near-winner's strategy which enhances the rate of catch-up for all opponents, to keep all game pieces in play for the entire game, to use chance to determine options for strategically relocating pieces on the game board, to continuously re-map playing board paths for pawn movement, to provide a game that works equally well for playing as teams or for playing as individuals, to have a game that can end in a tie, to provide pawn identification by both shape and color for enhancing enjoyment of the game by colorblind players, to robustly hold in place the interacting game pieces, to link cooperating components options to game board size, and to provide for game upgrades that increase tactical options. Other advantages of one or more aspects will be apparent from consideration of the drawings and ensuing description.

### DRAWINGS—FIGURES

In the drawings, closely related figures have the same numbers but different alphabetic suffixes.

FIG. 1 shows a perspective view of a game board.

FIGS. 2A to 2C show perspective views of different sizes of maze barrier members.

FIGS. 3A to 3D show perspective views of several configurations of pawns.

FIGS. 4A to 4C show perspective views of dice.

FIG. 5 is a perspective view showing how pawns and maze barrier members interact with the game board.

FIG. 6 is an orthogonal top view of a game board showing pawns and barrier members as would be typical of a two player game.

FIG. 7 is an orthogonal sectional view showing how pawns and maze barrier members fit into the holes and channels of the game board.

FIG. 8 is a perspective view showing a simple game board.

FIGS. 9A and 9B are perspective views of simple alternate embodiments of pawns.

FIGS. 10A to 10C are perspective views showing simple alternate embodiments of maze barrier members.

FIG. 11 is an orthogonal top view showing a hexagonal playing board.

FIGS. 12A to 12E are perspective views showing a plurality of embodiments of maze barrier members for the hexagonal playing board.

FIG. 13 is a perspective view showing an 8-sided die with numbers on each face.

FIG. 14 is a perspective view showing a cage barrier member.

FIGS. 15A and 15B are perspective views showing possible figures on a special 8-sided die.

FIG. 16A is a perspective view showing a stacking pawn.

FIG. 16B is an orthogonal cross sectional view showing a stacking pawn.

FIGS. 17A and 17B are perspective views showing alternate embodiments of stacking pawns.

FIG. 18 is an orthogonal cross sectional view showing the interoperability of a stacking pawn and a game board.

FIG. 19 is an orthogonal cross sectional view showing the stacking mechanism.

FIGS. 20A and 20B are perspective views showing flexible hinged maze barrier members.

FIG. 21 is a perspective view showing special features on one edge of a maze barrier member.

FIG. 22 is a schematic representation of computer based game players.

### DRAWINGS—REFERENCE NUMBERS

102—Game board
104—Channels
106—Square pad
108—Hole
110—Color A
112—Color B
114—Color C
116—Color D
118—Apron Panel
120—Two-color pad
122—Bandy cavity
202—Short length splayed end maze barrier member
204—Medium length splayed end maze barrier member
206—Long length splayed end maze barrier member
208—Alignment splay on end of maze barrier member
302—Hollow three-feature pawn
304—Solid three-feature pawn
306—Hollow five-feature pawn
308—Solid five-feature pawn
402—Standard 6-sided die
404—Special 6-sided die showing three of six faces
408—“1-B” face of special die
410—“2-B” face of special die
412—“3-B” face of special die
414—“Wild” face of special die
416—“Repeat” face of special die
418—“Jump” face of special die
702—T-top for maze barrier member
804—Parallel sided channel
904—Cylindrical rod pawn
906—Square rod pawn
1004—Short parallel sided maze barrier member
1006—Medium parallel sided maze barrier member
1008—Long parallel sided maze barrier member
1102—Hexagonal game board
1104—Hexagonal polygonal pad
1116—Hexagonal board apron
1118—Color E
1120—Color F
1202—Ridged hexagonal maze barrier member, one side length
1204—Ridged hexagonal maze barrier member, two side length
1206—Ridged hexagonal maze barrier member, three side length, zig-zag
1210—Ridged hexagonal maze barrier member, three side common corner
1208—Ridged hexagonal maze barrier member, three side length, U-shaped
1304—Standard 8-sided die
1402—Cage barrier member
1404—Polygonal plate
1406—Open cylinder
1408—Cage extensions
1502—Special 8-sided die
1504—“Cage” symbol on special die
1506—“Flip” symbol on special die
1604—Connector Plate
1606—Tapered engagement cylinder
1608—Upper pawn shape
1702A—Solid four feature stacking pawn
1702B—Hollow four feature stacking pawn
1704A and B—Connector plate
1708A—Four-feature solid upper pawn shape
1708B—Four-feature hollow upper pawn shape
2002—Maze barrier member with one flex hinge
2004—Maze barrier member with two flex hinges
2006—Flexible hinge
2102—Maze barrier member with top features
2104—Edge feature
2204—Computer game player
2206—Internet server

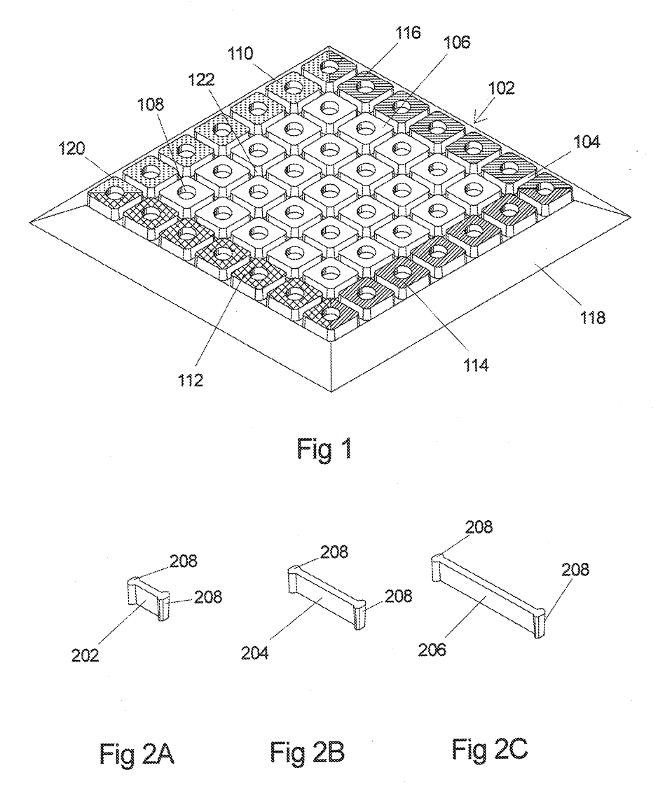

### DETAILED DESCRIPTION—FIGS. 1 THROUGH 4—FIRST EMBODIMENT

FIGS. 1, 2A, 2B, 2C, 3A, 3B, 3C, 3D, 4A, 4B, and 4C show perspective views of cooperating components for one version of a game system.

Referring to FIG. 1, the table top game system includes a substantially flat equal-sided polygonal playing surface or game board 102 arrayed with a plurality of equal-sided polygonal shapes which here forth will be referred to as pads 106. The pads 106 are interposed by a border means, optionally a generally uniform cross sectioned channel 104. The channel 104 is optionally tapered such that it is wider at the planar surface and narrower at the bottom of the channel 104. Optionally, the channels 104 may be increased in width to create a bandy cavity 122 at the corners of the pads 106. The increased width can optionally be accomplished by rounding the corners of the pads 106 from the top surface of the pad 106 down into the channels104. Each of the pads 106 also optionally has a centrally located hole 108. The board may also optionally include an edge panel or apron 118. In addition, all the pads 106 along each of the game board's 102 peripheral sides are identified with a color indicium. A unique color is used for each side of the game board 102. For example, a four sided board 102 would have only four unique colors, color A 110, color B 112, color C 114, and color D 116. Only one color is associated with each side. In addition, all the outermost adjacent pads 106 on each side of the playing board are identified with the same color. Two-color pads 120 at the intersection of two sides of the game board 102 are identified with the colors associated with the two sides that form the intersection. Colored pads are designated as HOME. There are as many HOMEs as there sides to the game board. Each HOME is identified by its unique color.

The material of the game board 102 can be any shatter and crack resistant material that has the characteristic of dimensional memory after manufacture and can be colored. For example, wood can be sawed, drilled, and painted to manufacture the game board. Plastics can be shaped by molding, or by additive processes like 3D printing or subtractive processes like machining. Metals can be bent and stretched. Materials can be rigid when finished or have some flexibility as long as it has dimensional stability. All materials can be colored as required by any of several standard industry processes or colors can be added to plastics prior to molding.

This example of a game board is meant to be instructive of a concept and does not include all possible features, special properties, or exception variations achievable by a person who is skilled in the art.

Referring to FIGS. 2A, 2B, and 2C, the table top game system includes a plurality of maze barrier members 202, 204, 206 of several lengths. The maze barrier members 202, 204, 206 are generally flat rectangular shapes of a thickness and shape such that they can be releasably inserted into the channels 104 of the board 102. Optionally, maze barrier members 202, 204, 206 can include a taper disposed on at least one of the longest edges. The angle and width of the taper is generally congruent with the channel 104 of the playing board 102. Referring to FIG. 7, as an option, an edge opposite and parallel to the tapered edge can have a T-section ridge or enlargement 702.

Referring again to FIGS. 1, 2A, 2B, and 2C, optionally, the maze barrier members may include splays 208 disposed along both short edges of each barrier member. The cross section of the splay has both congruence with the bandy cavity 122 at the intersection of the pad 106 corners and avoids spatial interference with up to three other barrier members that occupy the same bandy cavity 122.

The length of each maze barrier member 202, 204, 206 is generally a multiple of the length of one side of the pad 106 on the playing board 102 less the dimension required to prevent interference with an adjacent maze barrier member 202, 204, 206. For straight maze barrier members 204, 206 longer than one pad 106 side in length, the distance of channel 104 width between adjacent polygonal pads 106 must be added for each channel crossed. For example, the length of maze barrier member 204 is the sum of two pad 106 sides and one channel 104 width. The length of maze barrier member 206 is the sum of three pad 106 sides and two channel 104 widths.

The length of barrier members 202, 204, and 206 with splays 208 is sufficient to allow the splays to engage the bandy cavities 122 but short enough to not interfere with ends or sides of other barrier members 202, 204, and 206.

The material of the maze barrier members 202, 204, and 206 can be any shatter and crack resistant material that has the characteristic of dimensional memory after manufacture and can be colored. For example, wood can be shaped and painted to manufacture basic simple barrier members. Plastics can be shaped by molding, or by additive processes like 3D printing or subtractive processes like machining. Materials can be rigid when finished or have some flexibility as long as it has dimensional stability. All materials can be colored as required by any of several standard industry processes or colors can be added to plastics prior to molding.

This descriptive example of maze barrier members is meant to be instructive of a concept and does not include all possible features, special properties, or exception variations achievable by a person who is skilled in the art.

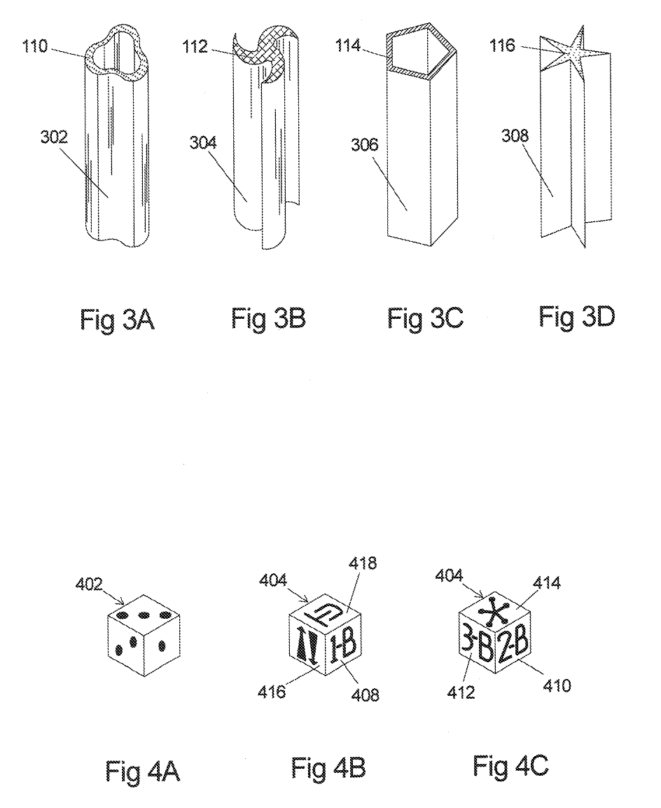

FIGS. 3A, 3B, and 3C show perspective drawings of pawns of distinctive shapes and colors. Referring to FIGS. 3A, 3B, 3C, and 3D, the table top game system also includes a plurality of position markers or pawns 302, 304, 306, and 308. The plurality of pawns is further divided into equally numbered sets wherein each set is uniquely identified by a single color or indicium. The number of sets of pawns 302, 304, 306, and 308 and of unique colors 110, 112, 114, and 116 is the same as the number of sides on the game board 102 and the unique colors for each pawn set are the same as the colors 110, 112, 114, and 116 on the game board 102. For example, for the game board 102 of FIG. 1 there are four sets of pawns 302, 304, 306, and 308, each of a different color110, 112, 114, and 116, matching one side of the game board 102.

Generally, pawns can be characterized as having a continuous cross-section along at least part of the axis. Pawns are flat on the ends and of a virtual outside diameter that is slightly smaller than the holes 108 in the game board 102. Pawn sets can optionally have unique identifying shapes, another indicium. For example: one set of pawns can have a tri-lobed 302 shape, another can have a three-armed spinner 304 shape, still another can have a pentagon 306 shape, and yet another can have a five pointed star 308 shape. Each pawn set can be uniquely identified by shape as well as color. In this example, a pawn set is comprised of a plurality of like shaped and like colored pawns. The dominate color of each pawn set is different from all other pawn sets and is matched to one of the colors 110, 112, 114, 116 on the outermost rows of the game board 102. The unique shapes help colorblind players in differentiating pawns.

Optionally, the unique identifying shapes of pawns could be embossed in the top surface of the board pads which match the pawn color.

The material of the pawns can be any shatter resistant material that has the characteristic of dimensional memory after manufacture and can be colored. For example, wood can be shaped and painted to manufacture the basic simple pawns. Plastics can be shaped by molding, or by additive processes like 3D printing or subtractive processes like machining. Materials can be rigid when finished or have some flexibility as long as it has dimensional stability. All materials can be colored as required by any of several standard industry processes or colors can be added to plastics prior to molding.

Above descriptions serve as examples and are not restrictive. For example: Pawns can be straight parallel sided or tapered sided or can be imaginary or fantastic figures. It is well known that game players, both children and adults, enjoy vicarious role playing in their games. Examples include chess which allows a player to pretend to be a in a medieval battle with an army and royalty. Another example is Dungeons and Dragons filled w/ imaginary characters and magical powers. In response to player's vicarious bias, pawns could be figures, possibly with moving parts.

Referring to FIG. 4A, the table top game system includes a random selection generator for numbers or a numbered die 402 that has only one unique number, not including zero, on each face. The highest number equals the fewest number of channels required to be crossed when moving a pawn from one side of the game board to the opposite side. For example, a standard die has six unique numbers and the board 102 of FIG. 1 has a minimum of six intervening channels 104 between the pads 106 on one side of the game board and the opposite side.

Referring to FIGS. 4B and 4C, the table top game system includes another random selection generator or a special die that has a different picture or alphanumeric expression on each side.

The faces of the special die are optionally as follows:

(a) “1-B” symbol 408.

(b) “2-B” symbol 410.

(c) “3-B” symbol 412.

(d) “Jump” symbol 420.

(e) “Repeat” symbol 416.

(f) (f) “Wild” symbol 414.

The material of the dice can be any material that has the characteristic of dimensional memory after manufacture and can have images embossed and colored. The dice manufacturing industry has standard materials for this.

This description is not meant to be restrictive, but rather meant to be meant to be instructive of a concept and does not include all possible variations achievable by a person who is skilled in the art. For example, there may be a need or desire to create dice of greater than six sides to change probability or to add game options.

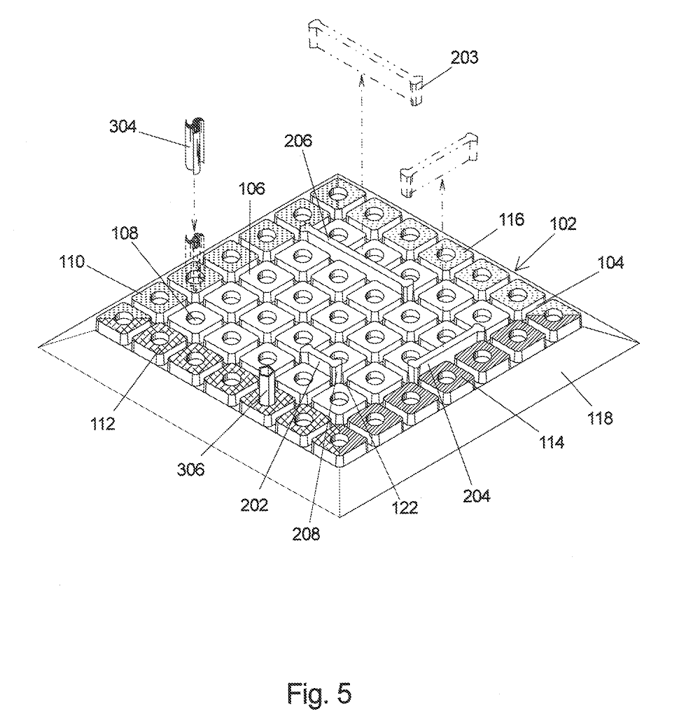

### Operation—FIGS. 5, 6, and 7

FIG. 5 is a perspective view of the four-sided game board 102 depicting the interoperability of maze barrier members 202, 204, and 206 and pawns 304 and 306 with the game board102. Maze barrier members 202, 204, and 206 are releasably inserted into game board channels 104 to impose allowable paths for the pawns 304 and 306 during game play. The ends of the maze barrier members 202, 204, and 206 align with a corner of a pad 106. Splays 208 on the maze barrier members 202, 204, and 206 fit onto bandy cavity 122 to help the alignment and also help keep the maze barrier members 202, 204, and 206 in place when a game board is lightly jostled during game play.

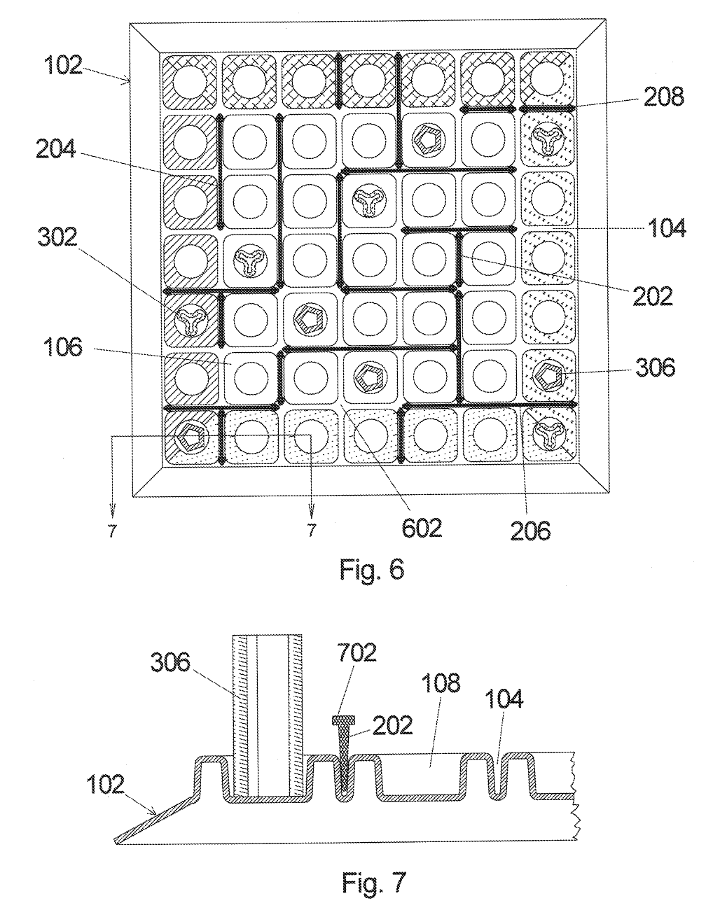

FIG. 6 is a top orthogonal view of a 4 sided game board 102 with randomly distributed maze barrier members 202 and pawns 302 and 306 for a two player game.

FIG. 7 is a cross sectional view showing the interoperability of the game board 102 with both pawns 306 and maze barrier members 202.

Referring to FIG. 5, holes 108 and channels 104 define acceptable positioning for the placement of cooperating game components. Each outermost row of pads 502 is colored 110, 112, 114, 116 differently in order to identify HOME pads for like colored pawns 304 and 306. The number of different colors equals the number of sides of the game board 102 polygonal shape. For example, one side of the game board 102 would have pads 106 of color A 110, another side would have color B 112, a third side would have color C 114 and a fourth side would have a color D 116. If a pad is shared by two sides then both colors on are the pad. For example, a game board with a square pad shape would have four colors, one color along each side of the board. The periphery of the game board 102 may have an optional edge panel or apron 118 to provide an aesthetic finish and a place for displaying the game name or other information.

Pawns 304 and 306 can be releasably inserted into a hole 108 in any game board pad 106 which is not already occupied by another pawn 306. Pawn 306 occupies a hole in one HOME row 502. Pawn 304 is shown being releasably inserted into a hole in a different HOME row. Maze barrier member 202 is one pad 106 in length and is shown inserted in a channel 104 between two adjacent pads 106. Maze barrier member 204 is two pads 106 in length and is shown being releasably inserted in a channel 104 next a HOME row of pads. Maze barrier member 206 is three pads in length and is shown being releasably inserted in a channel 104 parallel to maze barrier member 202 and perpendicular to maze barrier member 204.

A game board does not require holes and channels. The pads and colors for HOME row could be printed on a flat surface. Cooperating pawns and maze barrier members could be designed to stand independently on the game board surface.

As depicted in FIG. 6, maze barrier members 202, 204, 206 define the acceptable paths that pawn 302 or 306 may take during game play. All maze barrier members 202 are inserted into channels 104 at the beginning of the game, either in standard positions or by players taking turns placing. During game play, the path changes on almost every roll of dice, on each player's turn. There are always several options for placement of any length of maze barrier member 202, 204, 206. During his turn, if the option is displayed on the upper face of the rolled special die, the player typically repositions one maze barrier member 202, 204, or 206 into open channel 104 positons for the player's self-benefit and to impede any opponent. The resulting constantly changing maze has sufficient variations to seem infinite. This has the effect of a constantly and unpredictably changing the game board 102 layout.

Referring to FIG. 7, channel 104 and maze barrier member 202 interoperability is depicted. The angle and width geometry of the channel 104 and of the maze barrier member 202 are congruent. The angle assures that the width of the top of the channel 104 is wider than the bottom edge of the maze barrier member202. This width difference, in conjunction with the rounded corners of the channel 102 at the top surface of the game board 102, enhances the ease of insertion of the maze barrier member 202. The congruent angle of the channel 104 and the maze barrier member 202 also assures a snug non-wiggly fit. This enforced upright alignment enhances the consistency of visual demarcation of the continually changing maze barrier member layout on the board. The optional T-section 702 enhances gripping and widens the top of the maze barrier member to enhance visibility of the maze path layout on the game board 102. Optionally, barrier members 202 can be congruent with the channels on both of the longer edges.

Referring to FIG. 4 and FIG. 6, during game play and as indicted by the throw of the special die 404, maze barrier members 102 may be moved from one position in a channel 104 to any other position of sufficient length in any channel 104. When maze barrier members 202 are moved to another channel 104 on the game board 102, the allowable paths for pawns 302 and 306 change quite dramatically as the game progresses. This creates a constantly changing game board 102.

Referring to FIG. 6, the ends of maze barrier members 202 optionally have an alignment splay 208 to fit in the bandy cavity 122 at the intersection of game board channels. The splay 208 dimension is too large to fit in the channels 104 between pad sides; thereby assuring that, when inserted into the channels 104, the barrier members 202 will be held in position with ends always at a corner of a pad 106. The bandy cavity 122 is optionally produced when the corners of the pads 106 are rounded at the channel 104 intersections. The alignment splay 208 is shaped so that there is no interference when barrier members disposed adjacent to one another on the game board102. Adjacent includes either at corners or when the end of one barrier member 202 is perpendicularly aligned to a side of another maze barrier member 202. The length of barrier members 202 is appropriate to allow the alignment splays 208 to engage the bandy cavity 122, but short enough to not interfere with ends or sides of other barrier members 202.

It is possible for maze barrier members to have a base that holds the barrier member upright and thus can be used on a flat playing board with no channels.

Pawns are releasably inserted into the game board holes to indicate position and progress during game play. The pawns have a starting position on the opposite side of the board from their matching periphery color. For two players, each has five pawns. For more than two players each player has three pawns. During the game they are moved across the game board from a starting position to a HOME position, indicated by a pad with the color that matches the pawn color. A player wins by being the first to simultaneously position all pawns in the HOME row. When this happens, the game ends. Pawns are never removed from play; thus, no player is deprived of advantage by reduced pawn quantity. The number on the upper face of the numbered die determines how many times a channel must be crossed when moving a single pawn. Pawn moves are forward, backward, or sideways, but not diagonal. No pad may be used more than once in a move. A player cannot end a move on a pad that is occupied by his own pawn. However, a player can end a move on a pad occupied by an opponent's pawn. When this occurs, the player gets to re-position the opponent's pawn to any empty hole in the game board. This option can quickly rebalance the appearance of game advantage.

Referring to FIG. 7, the Pawn 306 is nested in a hole 108. This nesting of the pawn 108 makes for easy insertion and removal. Nesting also assures that pawn 108 stays in place in the presence of light jostling that may occur in game play.

Pawns can have a plurality of overlapping indicia. Referring to FIGS. 3A, 3B, 3C, and 3D, pawns are always discriminated by color110, 112, 114, and 116. Optionally, they can also be discriminated by shape. Pawns can have characteristics of hollow 302, 306 or non-hollow 304, 308 and also of a number of axially symmetric similar shapes. These similar shapes are features that are repeated and equally dispersed rotationally around the axis of the pawn. Refer to 302 & 304 for an example of 3 feature pawns. Refer to 306 & 308 for an example of 5 feature pawns. This shape organization allows teams to be formed with matching characteristics. Example: hollow versus non-hollow or 3 versus 5 axially symmetric features. Teams can thus be formed by players either across the playing board or with adjacent playing board positions. This capability expands the options and variety of game play. Discrimination by shape aids identity of team mates and opponents, especially for those players who may be color blind.

A means for positioning pawns on the pad is not necessary but can provide for robust placement during play. There are many alternate methods for achieving pawn placement. For example, a boss or projection rising from the surface of the pad could help position a pawn made with a hole in its bottom. For another example, a simple depression in the pad could help position a spherical pawn such as a marble. Another means for releasably positioning a pawn is a system of imbedded magnets in pawns that attract metal imbedded in the game board. I am not describing all means of holding the pawns, but only using examples to teach the concept of a means of releasably positioning and holding pawns on the game board. When a pawn is held but removable it is more robust to jostling that may occur during game play.

It is possible to have a game system that includes a flat game board with printed pads and no means of insertion interoperability. In this case the pawn can be made with a flat base that stands on its own.

Two dice are rolled by a player on her turn. One is a standard die and the other is a special die with a different picture or alphanumeric symbol on each face.

Referring to FIGS. 4A, 4B, 4C, and 6. On her turn, a player rolls a standard die and a special die and is required to make both moves if possible. The player can make the move on either die first. The standard die 402 us determine how many channels must be crossed by a single pawn without crossing any pad more than once. It is an equal-sided numbered die with one unique number indicated on each face of the die. The numbers start with 1 and increase consecutively to value determined by the fewest number of channels required to be crossed on the game board by a pawn going from stating position to HOME. For example, for the game board 102 in FIG. 6, the numbers on the die 402 would be 1, 2, 3, 4, 5, and 6 since 6 channels must be crossed when going from one side of the board to the opposite side. Determining the die numbering based on board channel quantity assures that a pawn can occasionally move from one side of the board to HOME in a single roll of the dice. This can be a move which helps rebalance apparent game advantage.

A special die 404 is used to determine options for moving or interacting with the maze barrier members and sometimes with the pawns. When rolled, the upper face of the special die indicates the option for the player as follows:
(a) “1-B” symbol 408 indicates that a player may move a maze barrier member, with a length of one pad, to any open channel position on the board.
(b) “2-B” symbol 410 indicates that a player may move a maze barrier member, with a length of two pads, to any open channel position fully contained on the board.
(c) “3-B” symbol 412 indicates that a player may move a maze barrier member with a length of three pads, to any open channel position fully contained on the board.
(d) “Jump” symbol 418 indicates that a player may jump over a maze barrier member.
(e) “Repeat” symbol 416 indicates that the player may take 2 moves as indicated on the standard die.
(f) “Wild” symbol 414 indicates that a player must choose any of the other options on the special die.
   The constant change of maze barrier member position results in pawn path changes driven by whatever the player thinks will benefit him and will impede the opponent. Thus, such changes will tend to rebalance advantage on almost every turn.

Game Set

First embodiment game set is comprised of:
a) a playing board of seven pads by seven pads as shown in FIG. 1
b) one set of 8 barrier members whose length is approximately the same as the length of one side of a playing board pad as shown in FIG. 2A,
c) one set of 8 barrier members whose length is approximately the same as 2 times the length of one side of a playing board pad as shown in FIG. 2B,
d) one set of 4 barrier members whose length is approximately the same as 3 times the length of one side of a playing board pad as shown in FIG. 2C,
e) 5 pawns of one solid color 110 and a hollow generally uniform cross-section having 3 axially symmetric similar shapes as shown in FIG. 3A,
f) 5 pawns of one solid color 114, different from previously described pawns, and a hollow generally uniform cross-section having 5 axially symmetric similar shapes as shown in FIG. 3C,
g) 5 pawns of one solid color112, different from previously described pawns, and a non-hollow generally uniform cross-section having 3 axially symmetric similar shapes as shown in FIG. 3B,
h) 5 pawns of one solid color 116, different from previously described pawns, and a non-hollow generally uniform cross-section having 5 axially symmetric similar shapes as shown in FIG. 3D,
i) one 6-sided special die as shown in FIGS. 4B and 4C, and
j) one 6-sided standard die as shown in FIG. 4A.

### Additional Embodiment

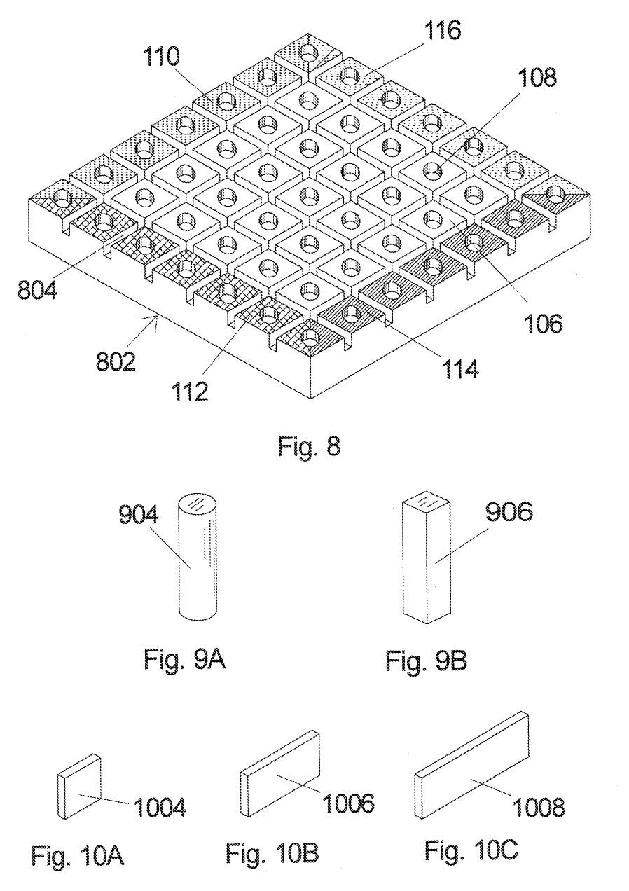

Referring to FIGS. 8, 9, 10, it is possible to have a simplified game board 802 with non-tapered channels 804, cylindrical rod pawns 904 or square rod pawns 906, and flat uniformly thick parallel sided maze barrier members 1008, 1006, 1004. The pawn shape can be very simple. An example is a short dowel. Referring to FIG. 9, the simplified cylindrical rods pawn 904 and optionally square rods 909 are identified by a different color for each pawn set. By using both cylindrical rod 904 and square rod 906 pawns, shape can be useful to help identify team pawns with cylindrical for one team and square for the other team. Referring to FIG. 10, a simple maze barrier member 1008, 1006, 1004 has no taper and no splayed end and fits into channels with no taper. Maze barrier members can be flat rectangular pieces of uniform predetermined thickness that releasably insert into the channels of the playing board.

As an alternate embodiment, some players will prefer to play the most basic game with the most basic and minimum options to play by the below rules. This embodiment is a game set comprised of:
a) a playing board of seven square pads by seven square pads shown in FIG. 8,
b) four color-distinguishable sets of five rod shaped pawns 904 shown in FIG. 9,
c) one set of eight flat rectangular barrier members 1004 whose length is approximately the same as the length of one side of a playing board pad shown in FIG. 10,
d) one set of eight flat rectangular barrier members 1006 whose length is approximately the same as 2 times the length of one side of a playing board pad shown in FIG. 10,
e) one set of four flat rectangular barrier members 1008 whose length is approximately the same as 3 times the length of one side of a playing board pad shown in FIG. 10,
f) one 6-sided special die 404 shown in FIGS. 4B and 4C, and
g) one standard die 402 shown in FIG. 4A.

### Alternate Embodiment

Another alternate embodiment increases the number of equal-sided polygonal shaped pads and holes. This embodiment can enhance the variation and complexity of available move options. Pads can be, but do not have to be square and do not have to be all similar shaped.

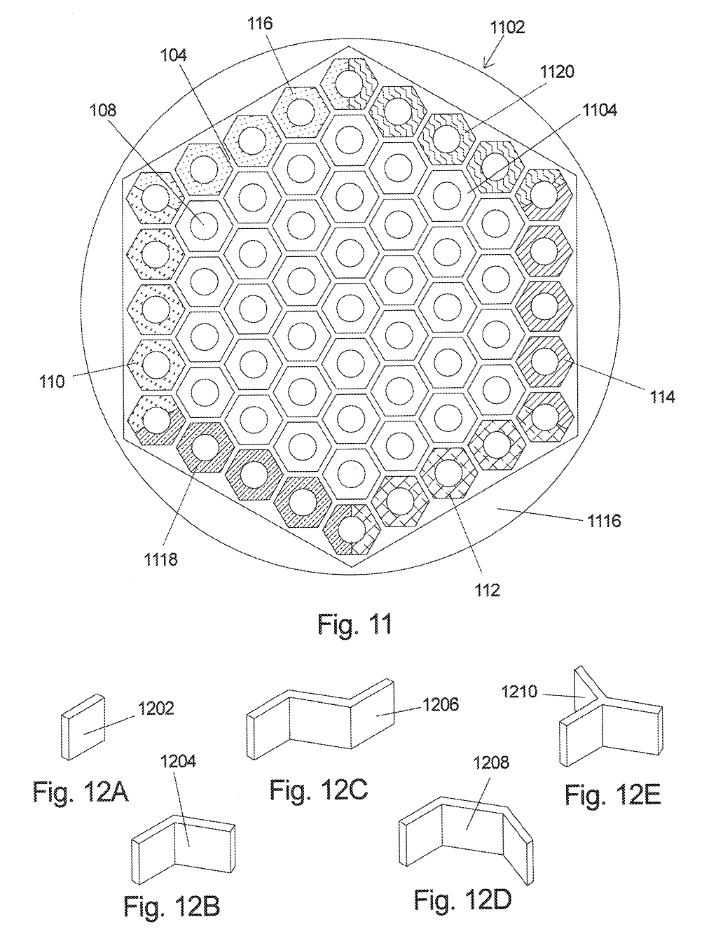

FIG. 11 is a top orthogonal view showing layout for a hexagonal game board 1102 with hexagonal pads 1104 that are interposed with channels 104. The game board has holes 108 and is circumvented with an apron 1116. There are six HOME rows, each with its unique color 110, 112, 114, 116, 1118, 1120. As discussed before, corner pads have two colors.

Other equal-sided polygonal shapes will also work, for example: a combination of octagons and squares.

Referring to FIG. 12, maze barrier members for hexagonal pads require no splaying to hold their positions with respect to the corners of the pad. This is because all channels have intersecting angles that prevent the barrier members from sliding beyond the corners of the pads. For example, a ridged hexagonal maze barrier member, one side in length 1202 is shown. The maze barrier member will remain in place since there is no section of straight channel longer than one pad side length. However, ridged shapes for maze barrier members that are greater than one pad side length must include the angle of the intersecting channels. The hexagonal maze barrier member, two sides in length 1204 that will fit adjacent to two pad sides has one angle and can be used with either angled edge in the channels. The maze barrier member that interposes three pad sides simultaneously has three possible configurations 1206, 1208, 1210, all of which can be used on either edge. Optionally, barrier members, straight or angled, can be more than three pad sides in length.

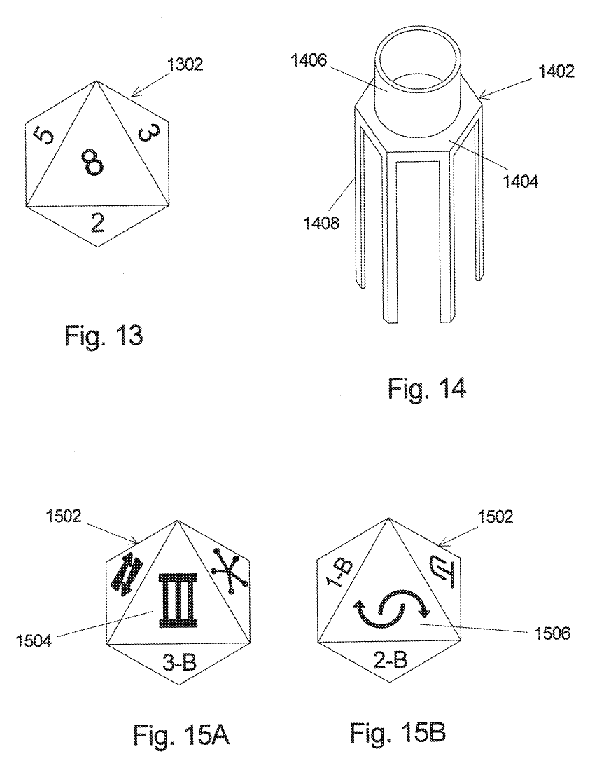

Referring to FIG. 13, in order to maintain the ability to move across the board with one roll of the number die, wherein the highest value of the numbered die is equal to the minimum possible number of channels crossed when moving a pawn from one side of the board to the opposite side, the hex board must use the standard eight-sided numbered die instead of the six-sided numbered die. FIG. 13 is a perspective view illustrating an eight-sided die 1302 which has eight equal faces with a different number from 1 to 8 on each face.

This alternate embodiment is a game set comprised of:
a) a playing board of 61 hexagonal adjacent pads as shown in FIG. 11 laid out with six edges, each edge comprised of five hexagonal pads.
b) one set of a plurality of barrier members whose length is approximately the same as the length of one side of a playing board pad as shown in FIG. 12,
c) one set of a plurality of barrier members whose length is approximately the same as 2 times the length of one side of a playing board pad as shown in FIG. 12,
d) one set of a plurality of barrier members whose cumulative length is approximately the same as 3 times the length of one side of a playing board pad as shown in FIG. 12,
e) 5 pawns of one solid color and a hollow generally uniform cross-section having 3 axially symmetric similar shapes as shown in FIG. 3A,
f) 5 pawns of one solid color and a hollow generally uniform cross-section having 4 axially symmetric similar shapes,
g) 5 pawns of one solid color and a hollow generally uniform cross-section having 5 axially symmetric similar shapes as shown in FIG. 3C,
h) 5 pawns of one solid color and a solid generally uniform cross-section having 3 axially symmetric similar shapes as shown in FIG. 3B,
i) 5 pawns of one solid color and a solid generally uniform cross-section having 4 axially symmetric similar shapes,
j) 5 pawns of one solid color and a solid generally uniform cross-section having 5 axially symmetric similar shapes as shown in FIG. 3D,
k) One 6-sided special die shown in FIGS. 4B and 4C,
l) One 8-sided standard die as shown in FIG. 13.

### ADDITIONAL ALTERNATE EMBODIMENTS

Expansion accessories are currently a popular method of enhancing game play of the basic game set. Some embodiments to the game system that fall under the category of expansion accessories optionally can be included as part of the original game system. Expansion accessories embodiments include a cage barrier member, 8-sided special die, stacking pawns, flexible hinged maze barrier members, and special featured edge maze barrier members.

### Alternate Embodiment

Referring to FIG. 14, a cage barrier member 1402 is comprised of an equal-sided flat planar polygonal plate 1404 of predetermined thickness, an open cylinder 1406 centered on and rising from one side of said polygonal plate1404, a plurality of extensions 1408 that are perpendicular to the side of the polygonal plate 1404 opposite the open cylinder 1406 and optionally disposed at each intersection of the sides of the polygonal plate 1404. The extensions 1408 could also be disposed at the midpoint of each side of the polygonal plate 1404. The shape of the polygonal plate 1404 is congruent with the pad of the game board on which the cage barrier member 1402 will be played. The dimension from side to side of the polygonal plate 1404 is generally the same as the game board pad plus two times the channel width. The inside diameter and depth of the open cylinder 1406 is substantially congruent with the hole in the game board. The length of the extensions 1408 is generally 1.2×the height of a pawn. The width of the extensions 1408 is congruent with the channels of the playing board.

The cage barrier member 1402 is a game upgrade component that changes strategy options. In game play, it would, like all other barrier members, be placed on the board at the beginning of the game by inserting the extensions 1408 into channels, thus enclosing one pad. Like other barrier members it cannot be crossed except by a “jump” symbol. It has its own “cage” symbol on the special die.

Refer to FIGS. 15A and 15B for a description of a special eight-sided die. The special 8-sided die 1502 has eight equal area faces. Six of the faces have the same symbols as used on the special 6-sided die. One face has a “cage” symbol 1504. Another face has a “flip” symbol 1056.

When the cage symbol 1504 is on the top face of a rolled die, the player must move the cage barrier member 1402 to a new position on the game board. If possible, the player can position the cage barrier member 1402 over an opponent's pawn. A pawn, thus enclosed by a cage barrier member 1402 is restrained from movement until the upper face of a dice roll has one of two options: either a “cage” symbol 1504 rolled by any player or a “flip” symbol 1506 rolled by player with the caged pawn. If the “cage” symbol 1504 is thrown, the cage is moved. If the “flip” symbol 1506 is thrown by the caged player, the pawn is moved from under the cage to the open cylinder 1406 and remains there until moved based on a numbered dice throw. If a cage barrier member 1402 is moved by a player while a pawn is releasably inserted in the open cylinder 1408, the player whose turn it is may choose to take the pawn with the cage barrier member 1402 or leave the pawn on the pad.

It should be noted that a cage can be designed to work with either a square or hexagonal pad. This description is not meant to be restrictive, but rather meant to be meant to be instructive of a concept and does not include all possible variations achievable by a person who is skilled in the art.

The material of the cage can be any shatter and crack resistant material that has the characteristic of dimensional memory after manufacture and can be colored. For example, plastics can be shaped by molding or by additive processes like 3D printing. Materials can be rigid or have some flexibility, as long as it has dimensional stability. Materials can be colored as required by any of several standard industry processes or colors can be added to plastics prior to molding.

### Another Alternate Embodiment

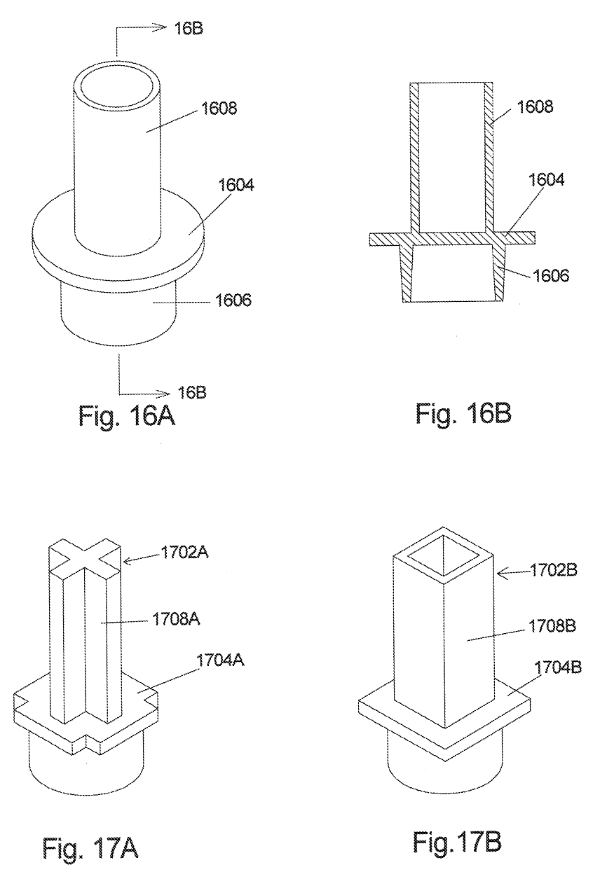

Referring to FIGS. 16, 17, 18, and 19, stacking pawns 1602 comprise a connector plate 1604, a tapered engagement cylinder 1606 and an upper pawn shape 1608.

Referring to FIGS. 16A and 16B, the connector plate 1604 serves as an attachment surface for the upper pawn shape 1608 and the lower tapered engagement cylinder 1606. The cross section in FIG. 16B shows the slight taper of the inside diameter of the tapered engagement cylinder 1606. The diameter increases with distance from the connector plate 1604.

The stacking pawn 1602 retains the previously described pawn features including hollow and non-hollow, and number of radially similar features.

FIGS. 17A and 17B are perspective views that illustrate how stacking pawns can have the differentiating characteristics previously described for non-stacking pawns. For example, FIG. 17A shows a solid 4 feature stacking pawn 1702 and FIG. 17B shows a hollow 4 feature stacking pawn 1704. The stacking pawns can have different number of features previously described for non-stacking pawns. Also note how the connecting plates 1704A and 1704B mimic the upper pawn shapes 1708A and 1708B.

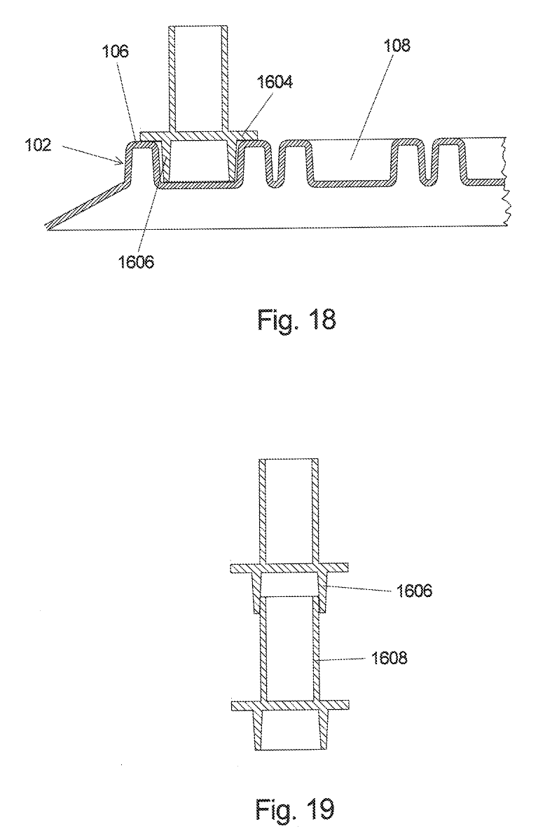

FIG. 18 is a cross sectional view showing the interoperability of the stacking pawn and the game board.

Referring to FIG. 18, the connecting plate 1604 sits on the top face of the pad 106 and provides a wider base than the standard pawn for enhanced stability. The lower tapered engagement cylinder 1606 fits into the game board 102 hole 108 to keep the pawn centered on the pad 106.

FIG. 19 is a cross sectional view showing the interoperability of the stacking feature for stacking pawns.

The lower engagement cylinder on all stacking pawns is dimensioned such that one stacking pawn can releasably attach to the top of any other stacking pawn. Referring to FIG. 19, the lower tapered engagement cylinder 1606 serves as a stacking engagement mechanism wherein the inside of the tapered engagement cylinder 1606 is angled to assure an interference fit with the upper pawn shape 1608, thus assuring a stable but removable attachment between the stacking pawns. This feature allows another game move option wherein one player may “capture and hold” an opponent's pawn by landing on it and attaching until a “flip” shows on the top surface of the special die.

Stacking pawns 1602 can further enhance game play by adding the element of capturing an opponent's pawn without removing it from the board. The captured pawn would be moved with the capturing pawn until the capturing player decides to release or until the captured player rolls an escape option on the special die.

The stacking feature pawn could be substituted in the game set for non-stacking pawns. In this case the “wild” symbol would be replaced with a “flip” symbol on one face of the 6-sided special die.

### Another Alternate Embodiment

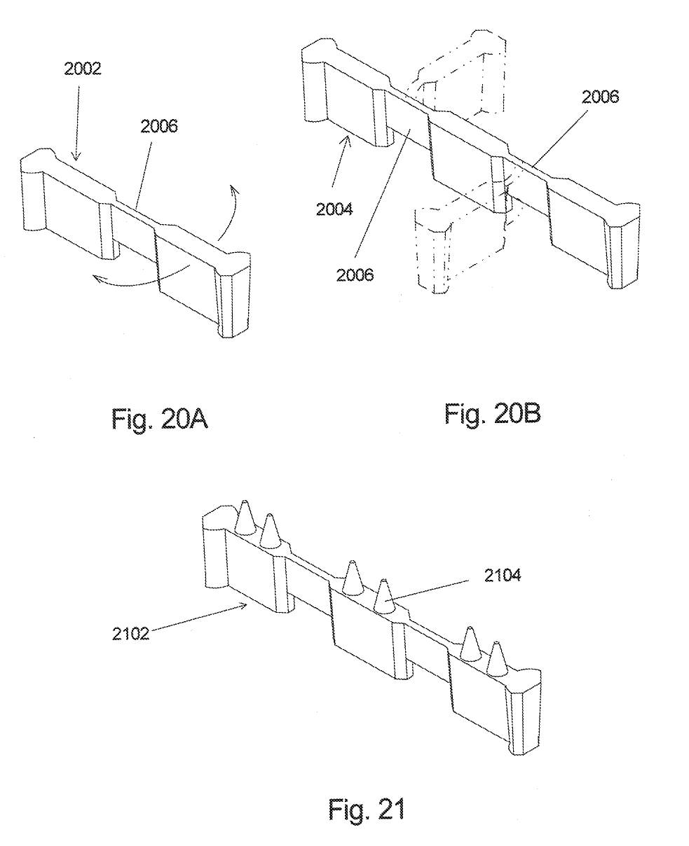

Referring to FIGS. 20A and 20B, the flexible maze barrier member is another expansion accessory that can optionally be included as part of the original game set. These maze barrier members have hinged or flexible sections that allow the maze barrier member to be inserted straight or to bend around corners formed by the channels of the game board. Such a maze barrier member design would broaden the game play options, enabling more defensive play. Referring to FIGS. 20A and 20B, for example, a maze barrier member 2002 with one flex hinge 2006 can be used as a straight maze barrier member or as an L-shape in either direction. A maze barrier member 2004 with two flex hinges can 2006 be used as a straight or for configurations of an L-shape or 2 configurations of a zig-zag-shape or 2 configurations of a U-shape.

### Another Alternate Embodiment

Referring to FIG. 21, another option is a maze barrier member with one edge modified to indicate different or special game properties. Referring to FIG. 21, a maze barrier member 2102 with top edge features 2104 could designate a barrier member with special properties or exceptions. For example, spikes as shown could prevent the “jump” option. Other top edge features could be used. Also top edge features could be used on either flexible or ridged maze barrier members.

It is expected that typical “after-market” expansion upgrades can include flexible hinged barrier members, special featured edge barrier members, cage barrier members, 8-sided dice, and stackable pawns. These same components could be included in the original game set.

### Another Alternate Embodiment

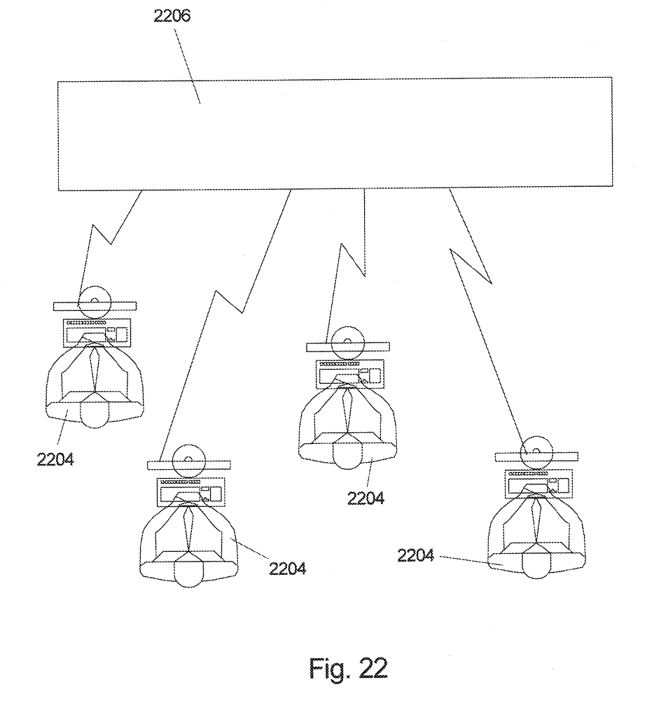

Referring to FIG. 22, all players A 2204, B 2206, C 2208, and D 2210 use a computer coded board, pawns, barrier members, and dice for playing with other people as opponents, either as individuals or as teams. The computer code also allows playing “solitare” with the computer code as the opponent. The computer code resides either on a player's own computer or on an internet based server 2212. The computer coded game has the advantage of players not having to be in the same location. In addition, a game can be interrupted and “saved” for finishing later. Players can watch a re-play of the game. Also, the computer code checks each move for validity. The computer code allows many more options for pawn shapes and supports animation. World-wide tournaments can be played with the computer code keeping records of player's win-lose records and displaying a leader board.

### Game Rules

The following game rules apply to all embodiments:

Game Board Set-up:

All players roll the standard die. Whoever rolls the highest number goes first. The first player chooses a color. All players' pawns are placed on the solid colored pads on the opposite side of the playing board from the pawn's matching colored pads. All maze barrier members are placed in a pile. The first player chooses a barrier member and places it in a channel on the playing board so that the ends of the barrier member align with corners of the pads on the game board. Players take turns choosing and placing the barrier members until all barrier members are placed. The cage is the last piece to be placed.

Number of players and pawns:

The square pad game can be played with two, three, or four players or two teams of two players (four players). With two players, each player gets five pawns. With more players, each player gets three pawns.

The hex pad game can be played with two to six individual players, or two or three teams of two players, or two teams of three players (six players). With two or three players, each player gets five pawns. With four or more players, each player gets three pawns.

Playing the Game:

When all barrier members and pawns have been positioned, the first player rolls both dice and moves according to the upper face of each die. The move on either die may be taken first, but must be completed before taking the move on the other die. If it is possible to make the move indicated on the die, it must be made, even if it requires moving your pawn off of a HOME pad. It is a valid strategy to make the move of one die first or second in order to prevent or allow the possibility of the move on the other die. After a player has finished both moves, play continues to the next player.

End of Game:

The first player or team with all their pawns on HOME pads is declared the winner and the game is over.

If a game can end in a tie, any player may declare a “Tinka's Tie” and the game is over.

For using the special die, a roll of:
“1-B” requires you to move any 1-B maze barrier member from its current position to any open position.
“2-B” is the same as 1-B but using a 2-B barrier member.
“3-B” is the same as 1-B but using a 3-B barrier member.
“Repeat” symbol indicates two moves of the standard die number. The same pawn may be used for both moves or different pawns may be used for each move.
“Jump” requires you to jump one of your pawns over any barrier member to an adjacent pad on the playing board.
“Wild” requires you to choose any of the other special die options.

Note: the following two points are included when using the 8-sided die:
“Cage” requires you to move the cage piece instead of a pawn from its current position to any available open pad. Open pads are any that do not have a maze barrier member on any side and are not occupied by your own or your team mate's pawn.
“Flip” applies to a single captured or caged pawn. For a captured pawn, it requires a player to reverse the positions of one stack so that the opponent is now in the lower “captured” position and you are in the “control” position. For a caged pawn, escape from the cage by placing the pawn on the top of the cage, allowing the pawn to move freely per the standard die roll.

Using the standard die:

The number on the upper face of the standard die indicates the number of pads on the playing board that you must move one of your pawns if possible. You can move your pawn along a path from pad to pad where sides are adjacent and the path is not blocked by a maze barrier member. No crossing at corners.

No pad may be used more than once during any one move. If it is impossible to move one of your pawns the required number of moves without moving on any pad more than once, you must forfeit the move.

When moving your pawn, you may move across pads occupied by other pawns. If your move ends on a pad occupied by an opponent's pawn, you must either remove your opponent's pawn and place it in an unoccupied square of your choice, or, if playing with the stackable pawn, you may capture your opponent and carry it with you on future moves. However, if the opponent's pawn occupies a pad with the color that matches their pawn (HOME) you may not remove it, you may not capture it, and you may not end your move on that pad. You may not end on a pad occupied by your own pawn, a team mate's pawn, or a cage.

These rules are not meant to limit the options on ways to use the game apparatus, but rather serve as an example. Other rules or variations can be used with the game apparatus and players often create their own variations. For example: a game with a barrier member that is four times the length of a pad side would be an extension of and consistent with the invention teachings

### Conclusion, Ramifications, Scope

Thus the reader will see that at least one embodiment of the game system and cooperating components provides a chance and strategy game wherein the layout, component density, and supporting rules urge continuing rebalancing of game advantage. As a result, the game is particularly fun for families where there may be dramatic age and experience difference. The overall effect of the game dynamics is to provide a plurality of “little wins” for every player during the game.

While my above description contains many specificities, these should not be construed as limitations on the scope, but rather an exemplification of several embodiments thereof. Many other variations are possible. For example: Pawns could be animals and maze barrier members could be fences. Special dice could have other symbols. The computer coded version could allow players to “construct” their own pawns and form ongoing teams with their own chosen team name.

Accordingly, the scope should be determined not by the embodiments illustrated, but by the appended claims and their legal equivalents.

We claim:

1. A game board system comprising in combination:
a. a substantially flat equal-sided polygonal playing surface of predetermined thickness that is sub-divided into a plurality of reticulated equal-sided polygonal pads with contiguous sides and an interposing border means disposed continuously at all said contiguous sides,
b. a plurality of home position indicium that are unique for each said equal-side of said equal-sided polygonal playing surface wherein said indicium are disposed on said polygonal pads that are further disposed on the periphery of said equal-sided polygonal playing surface,
c. a plurality of pawns each having a means for releasable placement on said polygonal pads generally mesial to said border means, each said pawn having at least one indicium that provides assignment to one of a plurality of pawn sets thereby providing a means for identifying each player's pawns and differentiating each player's game progress,
d. a plurality of barrier member structures each having a means for releasable placement at said border means thereby providing for pathway designation for said pawns to move toward said home position,
e. a random selection generator means with substantially equal opportunity for any one of a plurality of consecutive numbers wherein the lowest number is one and the greatest number equals the fewest number of said interposing border means that must be crossed to move said pawn across said equal-sided polygonal playing surface from a peripheral said polygonal pad on one side of said equal-sided polygonal playing surface to a peripheral said polygonal pad on the opposite side of said equal-sided polygonal playing surface thereby providing the number of said border means to be crossed by said pawn during a player's turn,
f. a random selection generator means with substantially equal opportunity for any one of a plurality of unique symbols thereby providing means for chance driven options for position changes for said barrier members, for said pawns to jump over said barrier members and for repeating a move with a said pawn thus allowing for said pathways to be continually changed during game play,
whereby said game board system provides means for a race-to-home game that continually changes the pathways to said home and rebalances odds of winning for each of a plurality of players.

2. The game board system of claim 1 wherein said interposing border means is a channel with a generally constant cross section including channel side angles measured from said flat surface within a range from 90 degrees to 90 degrees+/−15 degrees thereby forming either parallel sides or a truncated equal angled syncline.

3. The game board system of claim 2 wherein reticulated bandy cavities are disposed at each intersection of each said equal-side of all said polynomial pads.

4. The game board system of claim 3 wherein said barrier member structure is a generally flat rectangular slab element wherein the longest edge is substantially a multiple of the length of said equal-side of said polygonal pad and wherein thickness and shape of at least one long edge is congruent to said interposing border means whereby the barrier member is releasably disposed at the interposing border means.

5. The game board system of claim 4 having a splay along both short edges of said barrier member structure whereby the barrier member structure is releasably disposed into said interposing border means and simultaneously into said bandy cavities thus aligning the barrier members with the corners of said polygonal pads.

6. The game board system of claim 4 whereby said barrier member structure further includes flexible hinged sections wherein additional pathway options for said pawns are made available.

7. The game board system of claim 4 wherein said barrier member structure further includes features on the top edge whereby special rules apply.

8. The game board system of claim 1 wherein holes are substantially centered in said polygonal pads whereby pawns may be releasably inserted.

9. The game board system of claim 1 wherein an apron is disposed on periphery of said equal-sided polygonal playing surface whereby art work or information may be displayed.

10. The game board system of claim 1 wherein said barrier member structures are substantially a multiple of the length of said equal-side of said polygonal pad and further including angular shapes that are congruent with any angular shapes formed along the sides of the polygonal pads and having cross sectional congruence with said interposing border means.

11. The game board system of claim 1 wherein each said pawn possesses a plurality of overlapping indicia whereby the pawns can be divided into convenient sets which are characterized by only one indicium as required for individual or team play.

12. The game board system of claim 1 wherein said pawns further include means for releasably attaching the bottom of one pawn to the top of any other pawn thereby allowing more options for interoperability during game play.

13. The game board system of claim 1 wherein said random selection generators are three dimensional solids with equal area flat sides wherein only one number or symbol is displayed on each flat side.

14. The game board system of claim 1 wherein said barrier member structure further includes a cage shape that releasably fits at said interposing border means and surrounds a single said polygonal pad wherein said pawns can be temporarily prevented from moving from the polygonal pad when the cage shape covers the polygonal pad and the pawn.

15. The game board system of claim 1 wherein computer code creates virtual game components sufficient for internet based play.
